(19) United States
(12) Patent Application Publication
(10) Pub. No.: US 2009/0012896 A1
(43) Pub. Date: Jan. 8, 2009

(54) SYSTEMS AND METHODS FOR AUTOMATED VENDOR RISK ANALYSIS

(76) Inventor: James B. Arnold, Greensboro, NC (US)

Correspondence Address: KILPATRICK STOCKTON LLP, 1001 WEST FOURTH STREET, WINSTON-SALEM, NC, 27101, US

(21) Appl. No.: 12/094,481

(22) PCT Filed: Dec. 18, 2006
(86) PCT No.: PCT/US06/48171

§ 371 Date: Aug. 27, 2008

Related U.S. Application Data
(60) Provisional application No. 60/751,200, filed on Dec. 16, 2005.

(51) Int. Cl. G06Q 40/00

(52) U.S. Cl. 705/39; 705/1

(57) ABSTRACT

Systems and methods for automated vendor risk analysis are described. In one described method for automated vendor risk analysis, an analyzer receives payment transaction data associated with a vendor, compares the payment transaction data to a plurality of vendor fraud control measures, identifies the vendor or transaction associated with the payment transaction data as potentially fraudulent, and generates a notification regarding the potentially fraudulent vendor or transaction.

### CROSS-REFERENCE TO RELATED APPLICATIONS

This application claims priority to U.S. Provisional Patent Application No. 60/751,200, filed Dec. 16, 2005, entitled “Systems and Methods for Automated Vendor Risk Analysis,” the entirety of which is hereby incorporated by reference.

### FIELD OF THE INVENTION

This invention relates generally to systems and methods for vendor fraud detection. More particularly, embodiments of this invention relate to systems and methods for automated vendor risk analysis.

### BACKGROUND OF THE INVENTION

In order to acquire the resources a company needs to function, the company must deal with a variety of vendors. In the case of large, multi-national corporations, the list of vendors with which the company deals may reach into the tens of thousands. And the company may add hundreds of vendors to its vendor list every day.

In such an environment, it can be difficult to identify fraudulent or potentially fraudulent vendors. And when they are identified, it may be too late to effectively respond. Despite the difficulty in identifying potentially fraudulent vendors in a timely manner, companies must have a duty to do so. This duty arises due to various factors. The officers and board of a company have a fiduciary duty to adequately safeguard the company's resources. In addition, the Sarbanes-Oxley regulations require that a company have an anti-fraud program in place. Section 404(a) of the Sarbanes-Oxley Act addresses management's responsibility for establishing and maintaining adequate internal controls to minimize exposure to abuse. Sarbanes-Oxley has added pressure to control and monitor initial and continuing vendor transactions.

Responsibility for monitoring and other aspects of an anti-fraud program typically rests with a compliance officer or Chief Financial Officer (CFO). The compliance officer or CFO performs, or more typically, has one of his or her subordinates perform, various simplistic automated and manual processes in an effort to identify potentially fraudulent vendors. However, these conventional processes are insufficient to cope with the speed at which vendors are added to the mix. Service providers, such as eCustoms of Buffalo, N.Y. (www.ecustoms.com), provide niche services to deal with some aspects of vendor authentication. Credit card companies typically utilize fraud detection schemes to detect fraudulent use of a consumer's credit card. For example, a transaction may be flagged as potentially fraudulent if the amount of a transaction or of several closely spaced transactions exceeds a predetermined threshold or if a transaction occurs in an unexpected locale.

In addition, U.S. Application Publication Nos. 2003/0097330 and 2003/0069820 disclose systems and methods for detecting fraudulent transactions between a vendor and a customer. The systems and methods disclosed in these patent applications examine parameters of the transaction under examination as well as prior non-fraudulent transactions to determine the likelihood that the present transaction is fraudulent.

Efficient methods and systems for automated vendor risk analysis are needed.

### SUMMARY

Embodiments of this invention-provide systems and methods for automated vendor risk analysis. In one embodiment, a method for automated vendor risk analysis comprises receiving payment transaction data associated with a vendor, comparing the payment transaction data to a plurality of vendor fraud control measures, identifying the vendor or transaction associated with the payment transaction data as potentially fraudulent, and generating a notification regarding the potentially fraudulent transaction or vendor. In another embodiment, a computer-readable medium (such as, for example random access memory or a computer disk) comprises code for carrying out such a method.

These illustrative embodiments are mentioned not to limit or define the invention, but to provide examples to aid understanding thereof. Illustrative embodiments are discussed in the Detailed Description, and further description of the invention is provided there.

Advantages offered by the various embodiments of this invention may be further understood by examining this specification.

### FIGURES

These and other features, aspects, and advantages of the this invention are better understood when the following Detailed Description is read with reference to the accompanying drawings, wherein:

FIG. 1 is a block diagram of an illustrative environment for implementation of an embodiment of this invention;

FIG. 2 is a flow chart illustrating a process for receiving and normalizing data in one embodiment of this invention;

FIG. 3 is a flowchart illustrating a process of vendor verification in one embodiment of this invention;

FIG. 4 is a diagram illustrating a process and system for vendor verification in one embodiment of this invention;

FIG. 5 is a table illustrating a Benford analysis performed by an analytical engine 116 in one embodiment of this invention;

FIG. 6 is a table illustrating various fraud flags and risk scores in one embodiment of this invention; and

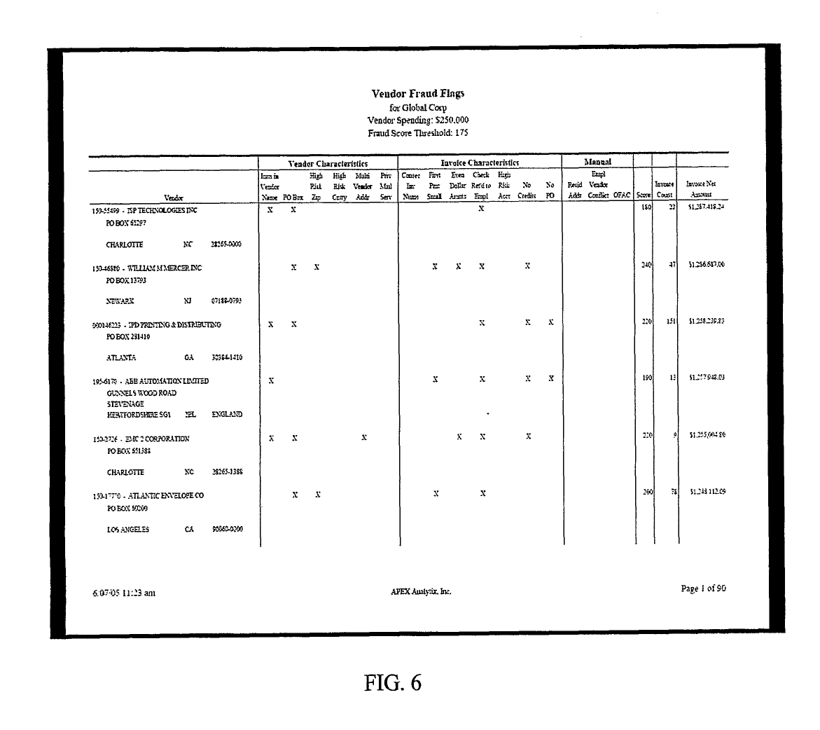

FIG. 7 is a screen shot illustrating a report creation user interface in one embodiment of this invention.

### DETAILED DESCRIPTION

Embodiments of this invention provide systems and methods for automated vendor risk analysis.

### Illustrative Vendor Verification

In one illustrative embodiment of this invention, a service provider leverages both technology and skilled scrutiny to isolate and report high-risk situations and transactions. Using an analytical engine implemented in software, the service provider analyzes client-provided vendor data to identify vendors with high-risk characteristics. The service provider may provide a report, such as the Vendor Verification Report shown in Appendix A.

Initial examination is via automated software routines. The set of vendors reviewed can be determined based on the company's spending with the vendor. A threshold can also be established according to the risk points assessed to the vendor. The result is a fraud flag report that lists vendors according to the spend and risk point thresholds set.

The software highlights vendors that (i) cannot be authenticated via public directories, and (ii) vendors associated with additional high risk indicators, such as appearance on government compliance and enforcement watch lists, vendors submitting invoices having consecutive numbering or even dollar amounts, or a series of invoices in which the first payment is small when compared to the average invoice amount. A manual review on the high risk vendors presented on the Vendor Risk Analysis Report may include a review to determine vendors operating out of residential addresses or private mail services, and verification against independently published directories, paid data retrieval services, and/or state incorporation records.

The system also evaluates consistency in vendor documentation as a means of establishing validity. For instance, vendor documents (i.e. invoices, statements, etc.) are examined for inconsistencies and irregularities. This step in the process minimizes the risk of paying incomplete invoices—another method of submitting invalid invoices.

In the report shown in Appendix A, five “Residential Vendors” are identified with spending in excess of $100,000 that appear to be sole proprietors operating from a residential address. In addition, two “Government Risk Vendors”, which appeared on a government compliance and enforcement watch list. No high-risk vendors below $50,000 were identified.

In the example shown, using predetermined criteria, the service provider evaluates the organization's vendors based on a scoring system in which a score of 150 signifies a high risk.

This example is given to introduce the reader to the general subject matter discussed.

The invention is not limited to this example.

### System Description

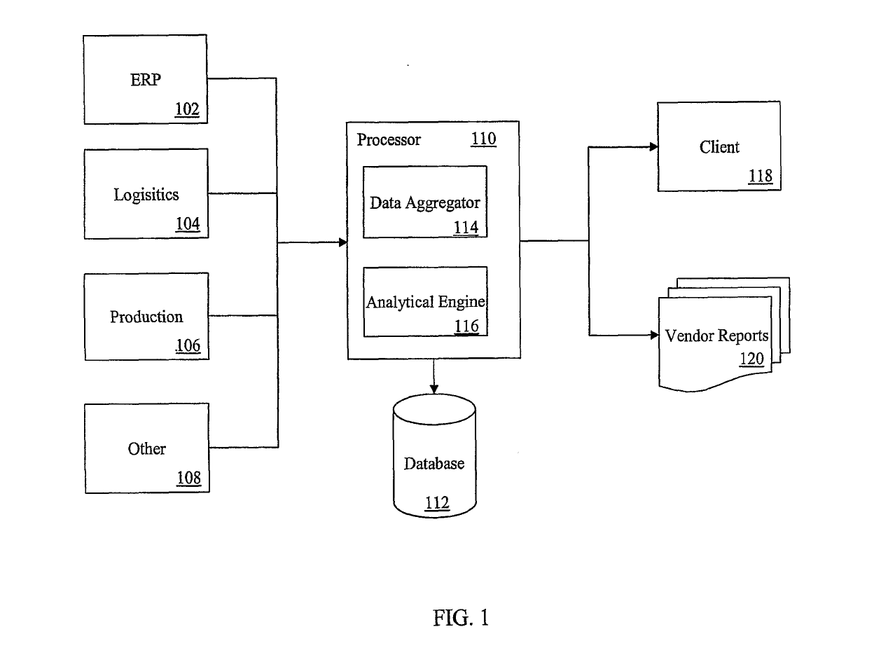

FIG. 1 is a block diagram of an illustrative environment for implementation of an embodiment of this invention. In the embodiment shown, an organization utilizes a variety of information systems, including an Enterprise Resource Planning (“ERP”) system 102. The ERP system 102 may, for example, manage invoices and payments from the organization's vendors and maintain a vendor master file. The ERP system may also be used to manage the financial functions of the organization. Examples of vendors of ERP systems are SAP, Oracle, and Baan.

The organization also operates a logistics system 104. The logistics system 104 helps the company perform supply chain management. The logistics system 104 may share or rely on the ERP system 102 vendor file or may comprise an independent vendor file.

In the embodiment shown in FIG. 1, the organization also operates a production system 106. The production system 106 helps the organization manage the production process, including ordering of supplies as needed and providing information regarding products that are produced for the organization's customers.

The organization shown also operates other systems 108. These other systems 108 may include information technology (“IT”) systems for managing procurement of computers, copier, peripherals, and other equipment. These systems may also include vendor lists and may also contain contract details for various products and services.

For example, the organization may utilize a copier service. The copier service installs and supports the various copiers used throughout the organization. One of the systems encompassed by the other systems 108 may help to manage the contract with the copier service. For instance, the organization may be entitled to toner as part of the monthly fee for utilizing the copiers. Such details would be captured in the contract-management system.

In the embodiment shown in FIG. 1, information from each of these systems is fed to a processor 110. The processor 110 utilizes various software programs to aggregate and analyze the data from various systems. These software programs and the processes performed by these software programs are described in detail below.

The processor 110 communicates with a database 112. The database 112 stores aggregated data as well as information used to analyze the data from the various systems 102-108. For example, in one embodiment, the database 112 includes a directory of vendors that can be used to identify non-fraudulent vendors among vendors identified as high risk, eliminating some false positives. Other types of information may also be stored in the database 112.

The processor 110 includes two programs or sets of programs, a data aggregator 114 and an analytical engine 116. Although described in terms of software, these components may be implemented as hardware, firmware, or some combination or hardware, software, and firmware. These components may also be executed on multiple processors, independently of one another.

The processor 110 shown comprises a computer-readable medium, such as a random access memory (RAM) (not shown) coupled to the processor 110. The processor 110 executes computer-executable program instructions stored in memory, such as the analytical engine 116. Such processors may comprise a microprocessor, an ASIC, and state machines. Such processors comprise, or may be in communication with, media, for example computer-readable media, which stores instructions that, when executed by the processor, cause the processor to perform the steps described herein. Embodiments of computer-readable media include, but are not limited to, an electronic, optical, magnetic, or other storage or transmission device capable of providing a processor, such as the processor 110, with computer-readable instructions. Other examples of suitable media include, but are not limited to, a floppy disk, CD-ROM, DVD, magnetic disk, memory chip, ROM, RAM, an ASIC, a configured processor, all optical media, all magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, C, C++, C#, Visual Basic, Java, Python, Perl, and JavaScript.

When the analytical engine 116 generates vendor verification information, it may provide this information to a user in a variety of ways. For example, in the embodiments shown in FIG. 1, the analytical engine 116 provides data to a client 118. The client 118 may comprise a computer executing a browser, such as Microsoft's Internet Explorer. Alternatively, the data may be provided to the client 118 as a spreadsheet or multidimensional database that can be accessed and manipulated by a user.

Client 118 comprises a processor and memory and may also comprise a number of external or internal devices such as a mouse, a CD-ROM, DVD, a keyboard, a display, or other input or output devices. Examples of client 118 are personal computers, digital assistants, personal digital assistants, cellular phones, mobile phones, smart phones, pagers, digital tablets, laptop computers, Internet appliances, and other processor-based devices. In general, a client device 118 may be any type of suitable processor-based platform that is connected to a network or executing software directly and that interacts with one or more application programs. Client 118 may operate on any operating system capable of supporting a browser or browser-enabled application, such as Microsoft® Windows® or Linux. The client 118 shown includes, for example, personal computers executing a browser application program such as Microsoft Corporation's Internet Explorer™, Netscape Communication Corporation's Netscape Navigator™, and Apple Computer, Inc.'s Safarim or reporting and analysis applications, such as Cognos' PowerPlay online analytical processing tool.

The analytical engine may also generate reports 120. These reports 120 may be in various formats and include varying levels of detail. Examples of the types of reports that may be produced are illustrated by the data and figures provided in the sample report in Appendix A. The analytical engine may also produce other types of reports including other types of data.

### Aggregating Disparate Data

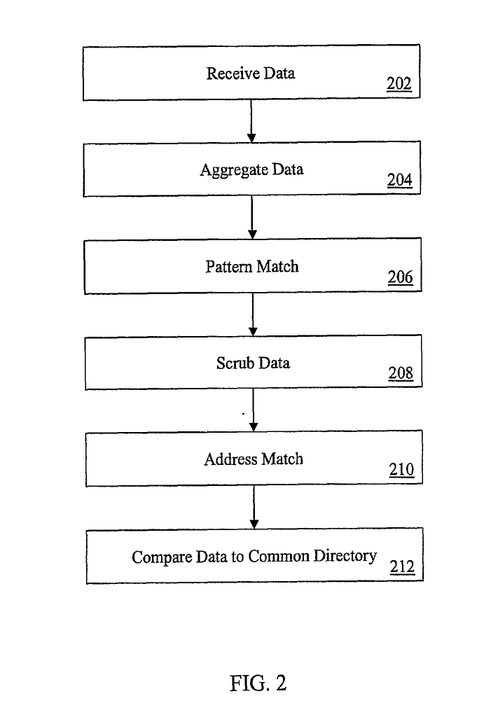

FIG. 2 is a flow chart illustrating a process for receiving and normalizing data in one embodiment of this invention. In the embodiment shown, the data aggregator 114, or another software program, receives data 202. The data may include ERP, logistics, production, or other data from the systems 102-108 shown in FIG. 1.

The data aggregator 114 then aggregates the data 204. Aggregation of the data may comprise parsing the data and loading it into a single table or set of tables in database 112.

The data aggregator 206 next scrubs the data, ensuring that all the data is in a consistent format (referred to as “scrubbed data”) 206. Scrubbing the data may include, for example, replacing all of the abbreviations in addresses with a standard format. For instance, the abbreviations “dr” and “drv” may be converted to “drive” in the address field of any record containing those abbreviations. Similar scrubbing may occur on other types of data such as name. For instance, “Inc” may be replaced with “Incorporated.”

In the embodiment shown in FIG. 2, the data aggregator 114 next performs an address match to eliminate duplicates in the aggregated data 208. For instance, the same vendor may be listed multiple times with slightly different names but the same address. These various vendor records are linked to a single vendor record so that all invoices or other information associated with this vendor are properly grouped.

The data aggregator 114 next performs pattern matching to eliminate additional duplicates in the aggregated data 210. Pattern matching may be more inclusive than address matching since address matching may require an exact match between two addresses before the data is considered a match.

In the embodiment shown, the data aggregator 114 next compares the data to a common directory 212. For instance, a common directory may be compiled for an industry that lists known vendors in the industry. The data may be compared to this directory to identify vendors in the aggregated data with data discrepancies, such as incorrect or incomplete addresses.

Further steps to clean the data may also be performed. For instance, the data may be compared with different or additional directories. Also, the data may be manually examined for quality assurance or other purposes.

### Vendor Verification

In embodiments of this invention, an application program may include a complex, computer algorithm that is intended to support vendor validation work, as well as become the standard for continuous monitoring of “at risk” vendors. By incorporating fraud knowledge from client embezzlements as well as vendor frauds previously isolated, this application refines the ability to spot questionable vendor activity. The application is capable of flagging vendors that possess certain attributes that in alone, in combination, or in total, indicate a higher propensity for fraud or vendor compliance violations. Risk points may be assigned to each of the various attributes of the vendor or of transactions with the vendor, and are summarized by vendor. The client can customize the risk point allocation for each of the attributes if certain tests should be assigned higher risk based upon their internal control environment. For example, vendors meeting established disbursement levels, and accumulating sufficient risk points may be highlighted for further review. Illustrative tests are described below, and can be performed on a periodic or real-time basis.

The Vendor Fraud Flags application receives data from a variety of system, such as an ERP system, and aggregates the data. The application then scrubs the aggregated data. The application then examine vendor and invoice attributes of the aggregated data to identify anomalies. Some of the vendor and invoice attributes are examine by conventional systems. However, the conventional systems do not examine the combination of flags examined by the Vendor Fraud Flags application. Nor do the conventional systems calculate a vendor fraud score (APEX score) and compare it to a threshold to identify potentially fraudulent vendors. In addition, feedback may be collected for both vendors and invoices to provide additional information to the application in identifying fraudulent vendors and invoices.

Embodiments of this invention may also be capable of identifying abusive practices, such as billing for work already paid for (e.g., toner cartridges paid for under a copier lease) and billing in excess of the actual products or services provided (e.g., charging for service on 10,000 items when only 500 were sold).

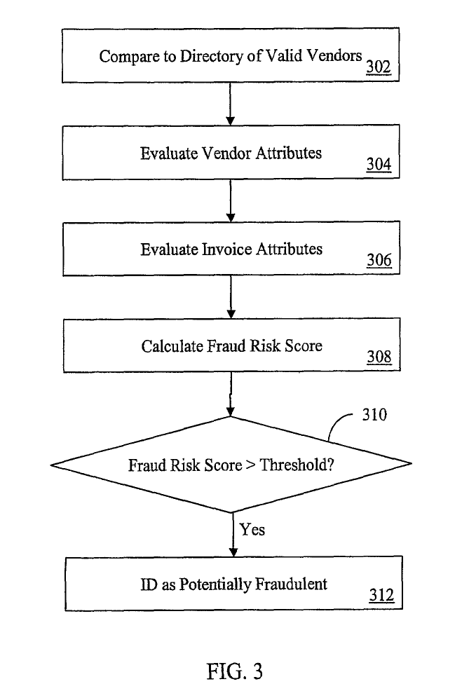

FIG. 3 is a flowchart illustrating a process of vendor verification in one embodiment of this invention. The steps shown in FIG. 3 are described as being performed by the analytical engine 116. However, other programs or combinations of programs may perform the steps. These steps may also be performed in a different order and performed independently or as part of an integrated audit of an organization's transactions.

Vendor verification refers to determining whether a vendor is potentially fraudulent. Fraudulent is used herein to describe activities that may be fraudulent in a legal context or activities that fall outside of parameters set by an organization but do not rise to the standard of fraud. For instance, a potentially fraudulent vendor would include a vendor that erroneously charged for a service included as part of a product purchase. While this erroneous charge may not be willful, it would still cause the vendor to be labeled potentially fraudulent by some embodiments of this invention.

The analytical engine 116 accesses database 112 to obtain the aggregated data and compares the aggregated data to a directory of valid vendors 302. By comparing the vendors to a list of valid vendors, the analytical engine 116 may be able to eliminate false positives, i.e., identifying a vendor as potentially fraudulent when they are known to be a non-fraudulent vendor. The directory of valid vendors may be specific to one organization. Alternatively, the directory of valid vendors may be applicable to a particular industry or industry segment. In one embodiment, the directory includes a list of valid vendors across multiple industries.

The analytical engine 116 then evaluates vendor attributes 304. Vendor attributes may be evaluated alone or in combination with other vendor attributes or other types of attributes, such as those described herein. The analytical engine 304 may evaluate a variety of vendor attributes. For example, the analytical engine 116 may search for initials in a vendor's name. If initials are found in the vendor's name, this may indicate a potentially fraudulent vendor. When creating fictitious vendors, embezzlers have been found to use only initials to make it more difficult to track or refute the existence of a vendor.

The analytical engine 116 may also attempt to determine whether the address contains a PO box. Many fictitious vendors use PO Box addresses. If the vendors hold themselves out as businesses by putting the address on an invoice, the true box holder and physical address can be obtained from the post office. In one embodiment, lock boxes are eliminated from the list of potentially-fraudulent vendors since the use of lockboxes can be very common.

The analytical engine 116 may also utilize high-risk zip codes in identifying potentially fraudulent vendors. For instance, in one embodiment, the analytical engine 116 accumulates risk points for vendors with addresses in predetermined high-risk zip codes. These high-risk zip codes can be updated by the client or may represent zip codes that have a propensity for fraud, e.g., parts of NY, NJ, California, Miami, border towns near Mexico, etc.

In one embodiment, the analytical engine 116 also utilizes the country attribute of the vendor, searching for vendors associated with high-risk countries. Countries represented may include the Balkans, Burma, Cuba, Iran, Iraq, Liberia, North Korea, Sudan, Syria, as well as others.

The analytical engine 116 may also evaluate the address of the vendor to identify multiple vendors as a single address. In one embodiment, the vendor is flagged if other vendors exist at the same address within a vendor list, such as a vendor master, and the vendors listed at a single address appear unrelated, i.e., they do not appear to be duplicate vendors. Specialized reporting may be utilized to view such vendors.

In one embodiment of this invention, the analytical engine 116 utilizes the address to identify vendors utilizing a private mail service. Private mail services such as Mail Boxes Etc. (now the UPS Store) are often used when creating fictitious vendors to give the appearance of an established company at a viable business address. Although used by legitimate businesses as well, these private mailboxes are usually changed once a business achieves a certain size and stability.

The analytical engine 116 may use an algorithm to determine whether an address is a residential address, which may constitute a very high risk. For instance, if the dollars disbursed to a residential address become too high to represent an individual contractor working out of his/her house, the information provides a strong indication of potential fraudulent activity. The address may also be used to identify addresses that are prison addresses. Such addresses have been linked to fraudulent activity in a number of cases;

The analytical engine 116 may also compare the vendor information with payroll or human resource files to identify employee/vendor matches, which may indicate fraudulent vendors. For example, in one embodiment, the vendor addresses and employee addresses are scrubbed to flag matches on address and telephone numbers. The analytical engine 116 may utilize state incorporation records, D&B filings, or other sources, to identify potential conflicts between an employee and vendor. These situations can be difficult to flag.

In some embodiments of this invention, the analytical engine 116 compares the list of vendors to a list of “scan vendors.” These are vendors that have been known to perpetrate scams against businesses, e.g., toner, job listings, etc., and also would include known consumer scams.

In yet another embodiment of this invention, the analytical engine utilizes information from the Office of Foreign Assets Control (OFAC). The US Department of the Treasury administers and enforces economic and trade sanctions based on US foreign policy and national security goals against targeted foreign countries, terrorists, international narcotics traffickers, and those engaged in activities related to the proliferation of weapons of mass destruction. These policies prohibit U.S. companies & individuals from transacting business with specially designated nationals (SDN). The SDN's are countries, individuals and companies tracked by OFAC, and there are civil and criminal penalties associated with doing business with these SDN's.

Referring still to FIG. 3, the analytical engine 116 next examines invoice-related attributes 306. Various invoice-related attributes may be examined. For example, in one embodiment, the analytical engine 116 identifies vendors using consecutive invoice numbering. Individual vendors with consecutive invoice numbering may be cause for concern. For instance, if a vendor's invoices are consecutive, it is unlikely this vendor is providing goods & services to other customers, which may reflect adversely on the vendor's stability.

The analytical engine 116 may also compare the first invoice payment to the average for the vendor. If the first payment issued to the vendor is quite small relative to the average payment, the vendor may be potentially fraudulent, and the analytical engine 116 will assign risk points accordingly. Many fraudulent vendors are set up initially on the basis of a $50-100 invoice, with the larger invoices processed once the vendor has been added to the vendor master. In one embodiment, if a vendor has experienced significant year-over-year increases in spending levels, the risk points assigned to the vendor will increase. In one such embodiment, the percentage increase is a parameter that can be modified by a client.

The analytical engine 116 may also identify vendors with invoice having even dollar gross amounts. With a few exceptions in professional services, invoices generally have both dollars and cents. Summing to total even dollar amounts is fairly unlikely, but happens more frequently when contrived invoice amounts are created.

In some embodiments, the analytical engine 116 attempts to identify checks that are to be returned to an employee. If an issued check is to be returned to an employee rather than being routed directly to the vendor, the risk for fraud is typically increased. The associated field within the data (usually a check handling code) should be verified for this flag to be effectively utilized.

The analytical engine 116 may also utilize the type of general ledger account to which disbursements are charged to allocate risk points. For example, the general ledger accounts that may be identified as potentially high risk are sales & marketing, miscellaneous & sundry, deferred accounts and intercompany accounts. A client may customize the list of high-risk accounts.

The analytical engine 116 may utilize other invoice attributes, such as credits and purchase order number. For example, once a vendor reaches a certain size, it is highly unusual to have no credit entries. Vendors with no credits may be assigned additional risk points. Vendors receiving invoice payments without associated purchase order numbers may also increase the number of risk points assigned to a vendor.

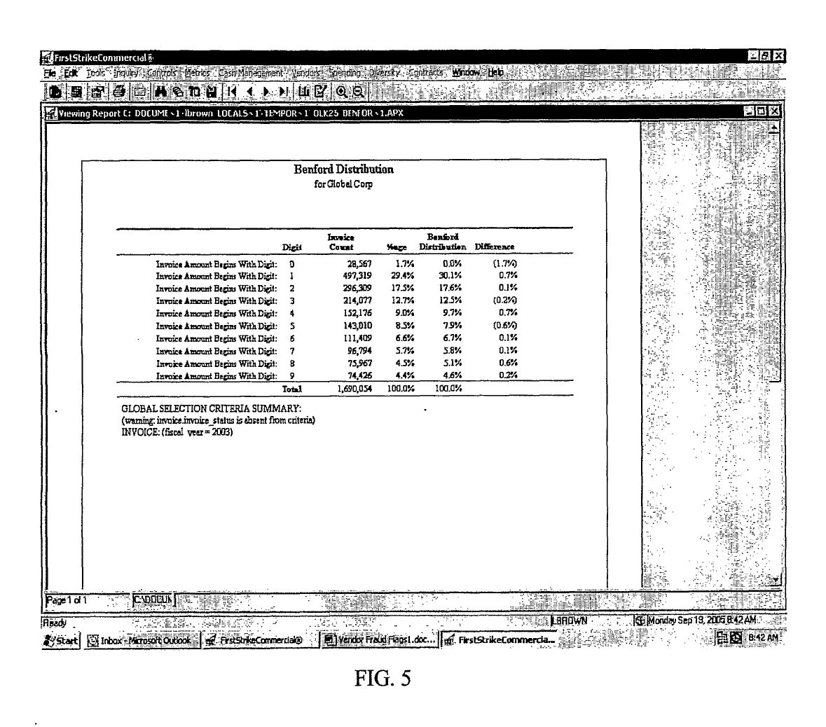

In one embodiment of this invention, the analytical engine 116 utilizes Benford's law to assign risk points to vendors. The algorithm utilized by the analytical engine 116 tests test each vendor's transactions to determine if the numeric digits follow a predictable distribution. Intuitively, one would expect a range of numbers to begin with each digit 10% of the time (10% for 0, 10% for 1, 10% for 2, etc.). In reality, when testing sets of transactions from various sources, physicist Frank Benford identified a mathematical phenomenon (Benford's Law) that confirms that about 31% of the numbers had 1 as the first digit, 19% had 2, and only 5% had 9. If the numbers for a vendor do not conform to that distribution (+/−a certain percentage), it may indicate that the transactions were potentially fraudulent. FIG. 5 is a table illustrating a Benford analysis performed by an analytical engine 116 in one embodiment of this invention. Such an analysis may be particularly effective in identifying vendors evidencing abusive billing practices.

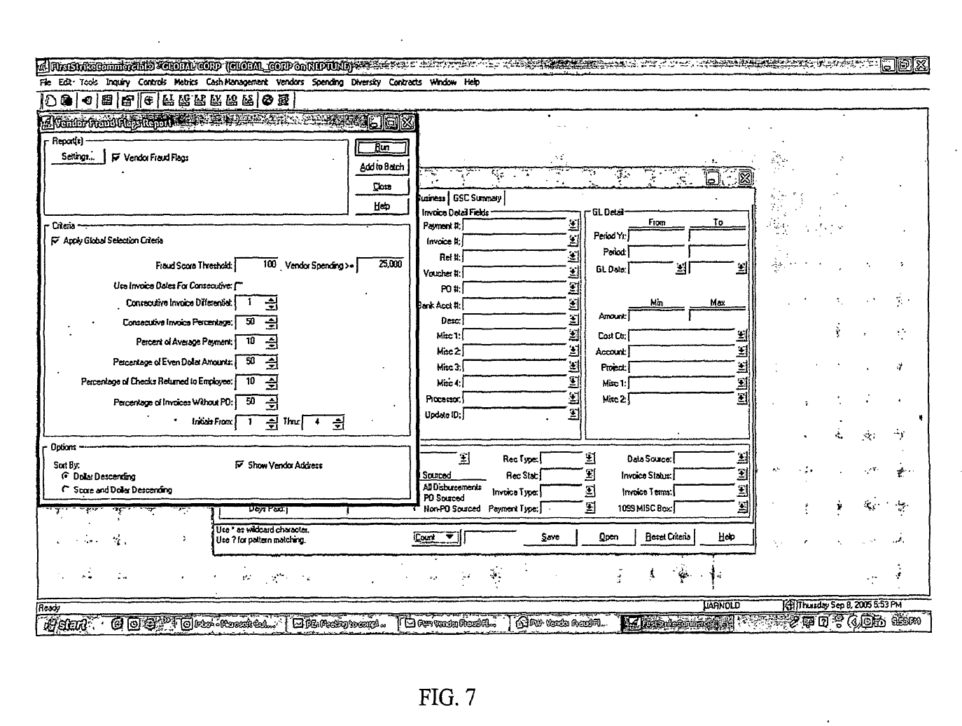

Referring again to FIG. 3, the analytical engine 116 next calculates a risk score 308. The risk score may simply be a sum of the number of risk factors associated with a particular vendor and the vendor's invoice. In one embodiment, each risk factor is associated with an individual weight, which is added to the total risk score associated with a vendor when a risk factor is identified. The sum of the individual weighted risk factors becomes the vendor's risk score. FIG. 7 is a table illustrating various fraud flags and risk scores in one embodiment of this invention.

The analytical engine 116 next compares the risk score to a predetermined risk score threshold 310. The threshold may be, for example, a default threshold, a threshold set for an individual client, or a threshold optimized for a particular industry. If the risk score is greater than the threshold, the vendor is identified as potentially fraudulent 312.

The process shown in FIG. 3 may be performed periodically (e.g., daily, weekly, or monthly) or on a semi real-time basis, i.e., continuous vendor monitoring. In some embodiments, the review is meant to isolate vendors with the greatest potential risk of fraud, based on an established dollar materiality (typically $25,000-$100,000 depending upon the size of the client vendor base). The report may be delivered first to an accounts payable (A/P) Director or Internal Audit/Corporate Security organization. Such a report may become an integral part of their internal control processes.

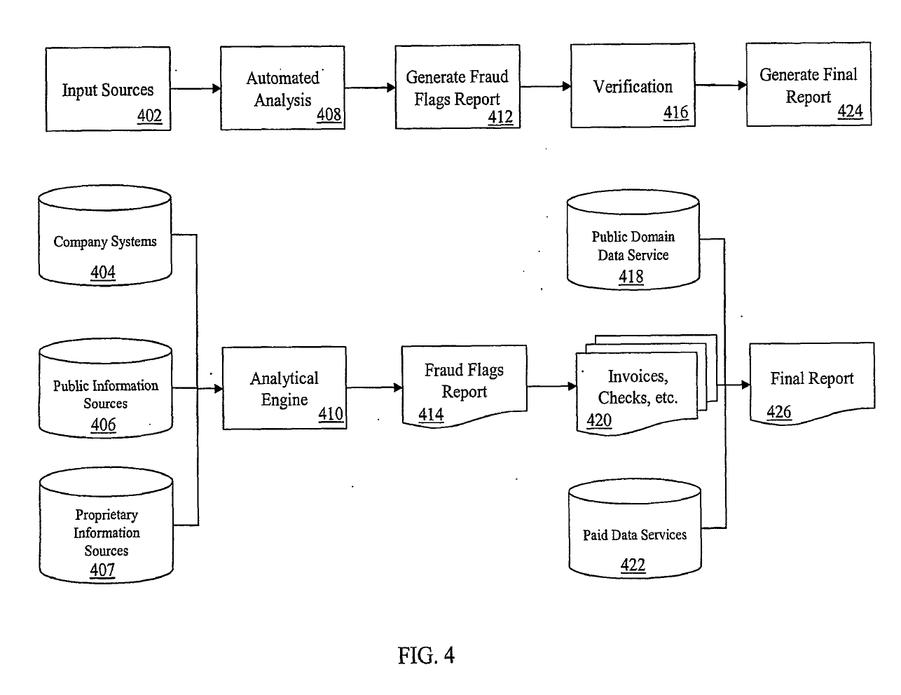

FIG. 4 is a diagram illustrating a process and system for vendor verification in one embodiment of this invention. The process shown may be referred to as an “at risk” vendor review process. In the embodiment shown, input sources 402 comprise various information for identifying potentially fraudulent vendors. The input sources 402 include data from company systems 404, data from public information sources 406, and data from proprietary information sources. The company systems 402 include information, such as payment, vendor, invoice, and employee data. The public information sources 406 may include, for example, OFAC lists, public mail box information, and prison addresses. Proprietary information 407 may include information such as high-risk general ledger accounts, high-risk addresses, payment handling codes, and previously identified scam vendors. This proprietary information may be identified using proprietary techniques and algorithms. The embodiment shown in FIG. 4 performs automated analysis 408 of the data.

This automated analysis 408 is performed by an analytical engine 410. The analytical engine combines the data from the company systems 404, public information sources 406, and proprietary information sources 407 to determine which vendors may be potentially fraudulent.

The result of the automated analysis is an automatically generated fraud flags report 412, 414. The fraud flags report 412, 414 identifies potentially fraudulent vendors. A verification process 416 is performed on the vendors in the fraud flags report 412, 414. The verification process 412 compares the fraud flags report 412, 414 to various information sources, such as public domain data sources 418, invoices, checks, and other records of transactions 420, and paid search services 420.

Once the data in the fraud flags report 412, 414 has been verified, the system generates a final report 424. The resulting final report 426 includes those vendors that were identified during the automated analysis and that were not eliminated during the verification process.

FIG. 7 is a screen shot illustrating a report creation user interface in one embodiment of this invention. In the embodiment shown, a user can set various criteria for producing a vendor fraud report.

In one embodiment of this invention, the analytical engine 116 is utilized to perform an initial high-risk identification. Additional processes may be utilized to confirm that these vendors are fraudulent. Document verification may also be performed.

Various organizations may use embodiments of this invention. For instance, forensic auditors that lack sufficient tools to perform detailed vendor validation. In addition, corporate auditors without domain experience or the necessary tools in place may use embodiments of this invention.

Such organizations may utilize the service in a variety of ways. For instance, a vendor may purchase the software and use it as a part of a continual auditing process. In one embodiment, the organization pays a per-vendor charge to an outsourced vendor verification service provider, leveraging proprietary resources and skill set of the service provider in order to obtain a cost-effective solution to their vendor compliance efforts.

### General

The foregoing description of the embodiments, including preferred embodiments, of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the this invention.

That which is claimed:

1. A method comprising:
receiving payment transaction data associated with a vendor;
comparing the payment transaction data to a plurality of vendor fraud control measures;
identifying the vendor or the transaction associated with the payment transaction data as potentially fraudulent; and
generating a notification regarding the potentially fraudulent vendor or transaction.

2. The method of claim 1, wherein identifying the vendor or the transaction as potentially fraudulent comprises:
determining a vendor fraud risk score based in part on the comparison between the payment transaction data and the plurality of vendor fraud control measures;
comparing the vendor fraud risk score to a vendor fraud risk threshold; and
identifying the vendor or transaction as potentially fraudulent if the vendor fraud risk score exceeds the vendor fraud risk threshold.

3. The method of claim 1, wherein the plurality of vendor fraud control measures comprises at least two of: a government list of prohibited persons and organizations, an address, a travel and expense, file, a list of scam vendors, or an invoice file.

4. The method of claim 1, wherein the vendor fraud risk score is associated with an instance of billing fraud, check tampering, or expense reimbursement.

5. The method of claim 1, wherein identifying the vendor or transaction associated with the payment transaction data as potentially fraudulent comprises flagging a plurality of categories of fraud associated with the payment transaction data.

6. The method of claim 5, further comprising comparing the flagged plurality of categories to supporting data.

7. The method of claim 6, wherein the supporting data comprises at least one of invoice data and payment data.

8. The method of claim 1, wherein generating a notification regarding the potentially fraudulent vendor comprises generating a vendor fraud flags report.

9. The method of claim 1, wherein the payment transaction data comprises vendor attributes and invoice attributes.

10. A computer-readable medium comprising executable program code, the computer-readable medium comprising:
program code for receiving payment transaction data associated with a vendor;
program code for comparing the payment transaction data to a plurality of vendor fraud control measures;
program code for identifying the vendor or the transaction associated with the payment transaction data as potentially fraudulent; and
program code for generating a notification regarding the potentially fraudulent vendor or transaction.

11. The computer-readable medium of claim 10, wherein program code for identifying the vendor or transaction as potentially fraudulent comprises:
program code for determining a vendor fraud risk score based in part on the comparison between the payment transaction data and the plurality of vendor fraud control measures;
program code for comparing the vendor fraud risk score to a vendor fraud risk threshold; and
program code for identifying the vendor or transaction as potentially fraudulent if the vendor fraud risk score exceeds the vendor fraud risk threshold.

12. The computer-readable medium of claim 10, wherein program code for identifying the vendor or transaction associated with the payment transaction data as potentially fraudulent comprises program code for flagging a plurality of categories of fraud associated with the payment transaction data.

13. The computer-readable medium of claim 12, further comprising program code for comparing the flagged plurality of categories to supporting data.

14. The computer-readable medium of claim 10, wherein program code for generating a notification regarding the potentially fraudulent vendor comprises program code for generating a vendor fraud flags report.

15. A method comprising:
receiving input data comprising at least one of Enterprise Resource Planning data, payment file data, logistics data, or production data;
aggregating the input data;
performing a pattern match;
scrubbing the input data to create scrubbed data;
performing an address match to eliminate at least some duplicates in the scrubbed data;
comparing the scrubbed data to a common directory to identify discrepancies for a vendor; and
identifying the vendor or transaction as potentially fraudulent based on the identified discrepancies.

16. A computer-readable medium comprising executable program, the computer-readable medium comprising:
program code for receiving input data comprising at least one of Enterprise Resource Planning data, payment file data, logistics data, or production data;
program code for aggregating the input data;
program code for performing a pattern match program code for scrubbing the input data to create scrubbed data;
program code for performing an address match to eliminate at least some duplicates in the scrubbed data;
program code for comparing the scrubbed data to a common directory to identify discrepancies for a vendor; and
program code for identifying the vendor or transaction as potentially fraudulent based on the identified discrepancies.
